(19) United States
(12) Patent Application Publication
(10) Pub. No.: US 2014/0319416 A1
(43) Pub. Date: Oct. 30, 2014

(54) EPOXY ENCAPSULATED FLUORESCENT COATING

(71) Applicant: Danny Warren, Carver, MA (US)

(72) Inventor: Danny Warren, Carver, MA (US)

(21) Appl. No.: 14/266,233

(22) Filed: Apr. 30, 2014

Related U.S. Application Data
(60) Provisional application No. 61/817,600, filed on Apr. 30, 2013.

(51) Int. Cl. C09K 11/02

(52) U.S. Cl. CPC C09K 11/025
USPC 252/182.14

(57) ABSTRACT

A structural epoxy coating blended with a high output fluorescent material. Further other materials may be blended in optimal embodiments including fumed silica and reflective beads. What sets this new product apart from others in the market is the fact that the product is extremely strong and rugged with extreme wear characteristics in very harsh conditions. The base epoxy, P301 epoxy manufactured by Warren Environmental, has passed the US Navy QPL list and is rated #1 based on navy testing for long term service life in sewer conditions. The base epoxy product is NAVSEA approved for salt water exposure and ocean spray, storage of hazardous materials, fuel tanks, salt water boxes, raw sewerage etc.

### CROSS-REFERENCE TO RELATED APPLICATIONS

This application is related to and claims priority from earlier filed U.S. Provisional Patent Application No. 61/817,600, filed Apr. 30, 2014.

### BACKGROUND OF THE INVENTION

The present invention generally relates to a coating system that emits radiant energy for long periods of time. More specifically, the invention relates to an epoxy encapsulated fluorescent coating material that emits radiation for long periods after initial excitation thereby greatly enhancing the visibility thereof.

There are numerous applications whereby night time or low light visibility is necessary for safety. By way of example, sea marker/navigational buoys, docks, safety walkways, emergency walkways, subway tunnels, hospital walls and hallway floors, the insides of light fixtures, mooring balls, markers for emergency escape routes, airport runway markers, non-skid walkways and lining of mine shafts are all applications that would benefit from luminescent materials in the event of main power and/or illumination failure. Further, such environments may employ a coating material to enhance the lighting and visibility thereof.

Presently such materials are employed in coatings that are soft and wear easily, resulting in such coating failing to perform in harsh environments or high wear locations.

In view of the foregoing, there is a need for a coating system that emits radiant energy for long periods of time. There is a further need for a highly durable and wear resistant epoxy encapsulated fluorescent coating material that emits radiation for long periods after initial excitation thereby greatly enhancing the visibility thereof.

### BRIEF SUMMARY OF THE INVENTION

In this regard, the present invention relates to a highly durable and wear resistant coating system using an epoxy encapsulated fluorescent coating material that emits radiation for long periods after initial excitation thereby greatly enhancing the visibility thereof.

The system comprises a structural epoxy preferably blended with a high output fluorescent material. Further other materials may be blended in optimal embodiments including fumed silica and reflective beads. What sets this new product apart from others in the market is the fact that the product is extremely strong and rugged with extreme wear characteristics in very harsh conditions. The base epoxy, P301 epoxy manufactured by Warren Environmental, has passed the US Navy QPL list and is rated #1 based on navy testing for long term service life in sewer conditions. The base epoxy product is NAVSEA approved for salt water exposure and ocean spray, storage of hazardous materials, fuel tanks, salt water boxes, raw sewerage etc.

The fluorescent, glow in the dark material is blended into the epoxy via high shear mixing. Further a thixotropic material such as Cabosil (fumed silica) may optionally be employed to better disperse the fluorescent material. Further, the fluorescent material coats the flakes of Cabosil (fumed silica) creating more emissive surfaces within the cured epoxy film. Once the materials have been thoroughly sheared into the epoxy, optionally the thixotropic material and reflective glass beads are added and slowly blended in. If reflective glass beads are employed they greatly enhance the overall brightness of the coating material. This blended coating can be sprayed to create a high build tough durable liner onto virtually any structure. Similarly, the product can also be brushed or rolled.

Possible applications of the coating include, but are not limited to, sea marker buoys, docks, safety walkways, emergency walkways, subway tunnels, hospital walls, hallway floors, the insides of light fixtures, mooring balls, markers for emergency escape routes, airport runway markers, nonskid walkways and lining of mine shafts. Further, the coating can be employed as a negative side water proofer and/or vapor barrier. In a situation like 9/11 when power supplies were exhausted, a product like this would have made search and rescue much easier. The compound will give off light for 12-15 hours once all outside light has been removed. The compound will fully recharge and begin emissions within only minutes of exposure to a light source.

Therefore, it is an object of the present invention to provide a new and novel coating composition that is highly durable and wear resistant while emitting light energy for long periods of time after excitation. It is a further object of the present invention to provide a highly durable safety coating that can be spray, brush or roll applied that includes a high output fluorescent material that generates illumination for at least 12 hours after energizing.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### DETAILED DESCRIPTION OF THE INVENTION

As can be seen the principal component of the coating system is a structural epoxy base material blended with a high output fluorescent material to provide high output coating response for extended periods of time. In this regard, the present invention relates to a highly durable and wear resistant coating system using an epoxy encapsulated fluorescent coating material that emits radiation for long periods after initial excitation thereby greatly enhancing the visibility thereof.

The system generally comprises a structural epoxy preferably blended with a high output fluorescent material. Further other materials may be blended in optimal embodiments including fumed silica and reflective beads. What sets this new product apart from others in the market is the fact that the product is extremely strong and rugged with extreme wear characteristics in very harsh conditions.

The structural base epoxy is preferably, P301 epoxy manufactured by Warren Environmental, has passed the US Navy QPL list and is rated #1 based on navy testing for long term service life in sewer conditions. The base epoxy product is NAVSEA approved for salt water exposure and ocean spray, storage of hazardous materials, fuel tanks, salt water boxes, raw sewerage etc. While a certain base epoxy is cited it should be appreciated that other structural epoxies having similar wear and durability characteristics could also be employed within the scope of the present invention.

The fluorescent, glow in the dark material is blended into the epoxy via high shear mixing. Further a thixotropic material such as Cabosil (fumed silica) may optionally be employed to better disperse the fluorescent material. Further, the fluorescent material coats the flakes of Cabosil (fumed silica) creating more emissive surfaces within the cured epoxy film. Once the materials have been thoroughly sheared into the epoxy, optionally the thixotropic material and reflective glass beads are added and slowly blended in. If reflective glass beads are employed they greatly enhance the overall brightness of the coating material. This blended coating can be sprayed to create a high build tough durable liner onto virtually any structure. Similarly, the product can also be brushed or rolled.

In a preferred embodiment, the coating is formed by first mechanically premixing either the hardener or polymer component of the epoxy with the luminescent/phosphorescent substance in incremental amounts, until thoroughly, evenly mixed. This “premixing” procedure, i.e., mixing the luminescent phosphorescent substance to one component of the epoxy before mixing together the two epoxy components, allows the epoxy component to thoroughly coat the luminescent powder particles, and permits even, thorough, homogeneous distribution of the luminescent particles within the epoxy component under industrial conditions. At the time of application, the pre-mixture may then be thoroughly mixed with the remaining epoxy component, assuring a homogenous distribution of the particles within the epoxy composition. The resulting composition may then be applied directly to the surface to be overlaid, before the epoxy cures.

After applying a composition containing this novel composition to a surface, structure or article, upon setting, the composition imparts wearability to the surface such as resistance to surface wear by tires of motor vehicles, airplanes, foot traffic, human handling/use, or elemental effects, such as the oxidizing acidic/basic action and humidity of the atmosphere and moisture, and thus provides an extended surface life. Thus, the surface can be covered with the transparent or translucent compositions, which does not affect the daytime appearance, but provides a resilient protective layer for the marking, and which makes the marking luminescent in dark conditions or non-daylight hours.

The overlay compositions of the present invention may also be used in marking any accepting surface on which luminescence is desired. For example, the compositions may be used to mark entire airport runways, highways and other roadways, pedestrian travelways, entire buildings/structures, or articles.

The luminescent substance in the compositions of the invention may be either a moisture sensitive phosphorescent substance such as a phosphorescent phosphor oxide type or a combination of a phosphorescent and a fluorescent substance. The preferred luminescent substance, but not limited to this particular phosphorescent pigment, contains phosphorescent phosphors which exhibit extremely long duration of afterglow. When the luminescent compositions include a combination of a phosphorescent and a fluorescent material, the fluorescent material present in the luminescent substance produces a daytime luminescence or reflectivity or coloration in addition to the phosphorescence produced at night.

The ideal ratio of luminescent substance to epoxy resin depends upon the intended use. As the ratio of parts of luminescent substance to epoxy resin increases, the intensity and duration of glow increases, but adequate particulate covering, bonding, binding, and overall strength decreases. Conversely, as the ratio of parts of epoxy resin to luminescent substance increases, the intensity and duration of glow decreases, but adequate particulate covering bonding, binding, and overall strength increases. Thus, in a preferred embodiment, the ratio of parts of luminescent substance to epoxy resin should provide a result where the epoxy fully encapsulates the luminescent substances particles, and binds with sufficient strength to its attached surface, and protects the overlayed surface/marking with sufficient strength, and the luminescent substance provides sufficient intensity and duration of glow. In a most preferred embodiment, the ratio of parts of luminescent substance to epoxy resin should provide a result where the epoxy binds with maximum strength to its attached surface, and protects the overlayed surface/marking with maximum strength, and the luminescent substance provides maximum intensity and duration of glow.

Possible applications of the coating include, but are not limited to, sea marker buoys, docks, safety walkways, emergency walkways, subway tunnels, hospital walls, hallway floors, the insides of light fixtures, mooring balls, markers for emergency escape routes, airport runway markers, nonskid walkways and lining of mine shafts. Further, the coating can be employed as a negative side water proofer and/or vapor barrier. In a situation like 9/11 when power supplies were exhausted, a product like this would have made search and rescue much easier. The compound will give off light for 12-15 hours once all outside light has been removed. The compound will fully recharge and begin emissions within only minutes of exposure to a light source.

It can therefore be seen that the present invention provides a new and novel coating composition that is highly durable and wear resistant while emitting light energy for long periods of time after excitation. Further, the present invention provides a highly durable safety coating that can be spray, brush or roll applied that includes a high output fluorescent material that generates illumination for at least 12 hours after energizing. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A luminescent epoxy overlaying composition, comprising:
a two-part epoxy including a resin component and a hardener/activator component that, after curing, is durable, tough and moisture stable;
a phosphorescent or luminescent material blended into said two-part epoxy; and
a thixotropic material blended with said two-part epoxy and said phosphorescent or luminescent material to better disperse said phosphorescent or luminescent material into said two-part epoxy;
wherein overlaying composition, when exposed to a light source, exhibits brightness properties superior to the brightness properties of conventional phosphorescent materials, and afterglow properties superior to, by exceeding by about ten times, the afterglow properties of conventional phosphorescent materials.

2. The luminescent epoxy overlaying composition of claim 1, further comprising:
reflective glass beads blended into said two-part epoxy.

3. The luminescent epoxy overlaying composition of claim 1, wherein said thixotropic material is fumed silica, said phosphorescent or luminescent material coating the outer surface of said fumed silica to create enhanced luminescent surface area within the composition.

4. The luminescent epoxy overlaying composition of claim 1, wherein said composition is applied by spraying.

5. The luminescent epoxy overlaying composition of claim 1, wherein said composition is applied by roller application.

6. The luminescent epoxy overlaying composition of claim 1, wherein said composition is applied by brush application.
